(19) United States
(12) Patent Application Publication
(10) Pub. No.: US 2015/0293424 A1
(43) Pub. Date: Oct. 15, 2015

(54) ELECTROPHORETIC ELEMENT, METHOD OF MANUFACTURING THE SAME, AND DISPLAY UNIT

(71) Applicant: Sony Corporation, Tokyo (JP)

(72) Inventors: Ken Kobayashi, Kanagawa (JP); Hidehiko Takanashi, Kanagawa (JP); Yuriko Kaino, Kanagawa (JP); Aya Shuto, Kanagawa (JP)

(21) Appl. No.: 14/356,542

(22) PCT Filed: Nov. 1, 2012
(86) PCT No.: PCT/JP2012/078290

§ 371 Date: May 6, 2014

(30) Foreign Application Priority Data
Nov. 22, 2011 (JP) 2011-255211

(51) Int. Cl. G02F 1/167

(52) U.S. Cl. CPC G02F 1/167; G02F 2001/1678

(57) ABSTRACT

An electrophoretic element according to the disclosure includes: an insulating liquid (1); a plurality of electrophoretic particles (10) provided in the insulating liquid (1); and a porous layer (20) provided in the insulating liquid (1) and having a fibrous structure (21). The electrophoretic particles (10) and the porous layer (20) have same charging polarity as one another.

### TECHNICAL FIELD

The present disclosure relates to an electrophoretic element including a plurality of electrophoretic particles in an insulating liquid, to a method of manufacturing the same, and to a display unit using the same.

### BACKGROUND ART

In recent years, as mobile devices represented by mobile phones and personal digital assistants become widely used, display units (displays) with low power consumption and high image quality have been increasingly demanded. In particular, lately, in association with birth of delivery business of electronic books, personal digital assistants (electronic book terminals) for the purpose of reading textual information for a long time have attracted attentions. Therefore, displays having display quality suitable for such a reading purpose have been desired.

Cholesteric liquid crystal displays, electrophoretic displays, electrochromic displays, twist ball displays, and the like have been proposed as the display for reading. In particular, reflective displays are preferable. Since the reflective displays perform light display by utilizing reflection (scattering) of outside light as paper does, the reflective displays provide display quality close to that of paper. Further, in the reflective displays, a back-light is not necessitated, and therefore, power consumption is kept low.

A major candidate of the reflective displays is the electrophoretic display that generates contrast by utilizing electrophoretic phenomenon, since power consumption is low and high-speed response is superior in the electrophoretic display. Therefore, various discussions have been made on display methods of the electrophoretic display.

Specifically, a method in which two types of charged particles each having different optical reflection characteristics are dispersed in an insulating liquid, and the charged particles are moved according to an electric field has been proposed (for example, see Patent Literatures 1 and 2). In this method, since the two types of charged particles each have opposite polarity, distribution state of the charged particles is changed according to an electric field.

Further, a method in which a porous layer is arranged in an insulating liquid, charged particles are dispersed, and thereby, the charged particles are moved through fine pores of the porous layer according to an electric field has been proposed (for example, see Patent Literatures 3 to 6). In this method, as the porous layer, a polymer film in which fine pores are formed by a piercing process with the use of laser, a cloth woven with the use of synthetic fibers and/or the like, an open cell foamed porous polymer, or the like is used.

### CITATION LIST

### Patent Literatures

Patent Literature 1: Japanese Examined Patent Application Publication No. S50-015115
Patent Literature 2: Japanese Patent No. 4188091
Patent Literature 3: Japanese Unexamined Patent Application Publication No. 2005-107146
Patent Literature 4: Japanese Examined Patent Application Publication No. S50-015120
Patent Literature 5: Japanese Unexamined Patent Application Publication No. 2005-128143
Patent Literature 6: Japanese Unexamined Patent Application Publication No. 2002-244163

### SUMMARY OF INVENTION

Although various display methods of the electrophoretic display have been proposed, the display quality thereof is not enough yet. In view of achieving color display, video display, and the like in the future, further improvement of display characteristics is desired, and more specifically, improvement of contrast is desired.

Therefore, it is desirable to provide an electrophoretic element capable of improving contrast, a method of manufacturing the same, and a display unit.

An electrophoretic element according to an embodiment of the present technology includes: an insulating liquid; a plurality of electrophoretic particles provided in the insulating liquid; and a porous layer provided in the insulating liquid and having a fibrous structure. The electrophoretic particles and the porous layer have same charging polarity as one another.

A method of manufacturing an electrophoretic element according to an embodiment of the present technology includes the following (A) to (C):

(A) forming electrophoretic particles;
(B) forming a porous layer configured of a fibrous structure; and
(C) introducing a functional group to one of the electrophoretic particles and the porous layer, the functional group adding a charging polarity to the one of the electrophoretic particles and the porous layer that is same as a charging polarity of the other one of the electrophoretic particles and the porous layer.

A display unit according to an embodiment of the present technology includes the above-described electrophoretic element provided between a pair of base substances, in which one or both of the base substances is light transmissive and each of the base substances is provided with an electrode.

In the electrophoretic element and the method of manufacturing the same according to the embodiments of the present technology, the electrophoretic particles and the porous layer are configured to have electric charges that are the same in charging polarity as one another. Thus, absorption of the electrophoretic particles into the porous layer is allowed to be suppressed.

According to the electrophoretic element and the method of manufacturing the same in the embodiments of the present technology, since the charging polarity of the electrophoretic particles and the charging polarity of the porous layer are configured to be the same as one another, absorption of the electrophoretic particles into the porous layer at the time of migration is suppressed, and contrast is improved. Therefore, a high-quality display unit with improved display characteristics is allowed to be provided.

### BRIEF DESCRIPTION OF THE DRAWINGS

FIG. 1 is a plan view illustrating a configuration of an electrophoretic element according to an embodiment of the present technology.

FIG. 2 is a cross-sectional view illustrating a configuration of the electrophoretic element.

FIG. 3 is a flowchart illustrating steps of manufacturing the electrophoretic element illustrated in FIG. 2.

FIG. 4 is a cross-sectional view illustrating a configuration of a display unit using the electrophoretic element according to one embodiment of the present technology.

FIG. 5 is a cross-sectional view for explaining operation of the display unit.

### MODE FOR CARRYING OUT THE INVENTION

An embodiment of the present technology will be described in detail with reference to the drawings. The description will be given in the following order:

### 1. Embodiment

### 1-1. Whole Configuration

### 1-2. Method of Preparing Electrophoretic Particles

### 2. Application Example

### 3. Examples

### 1. Electrophoretic Element

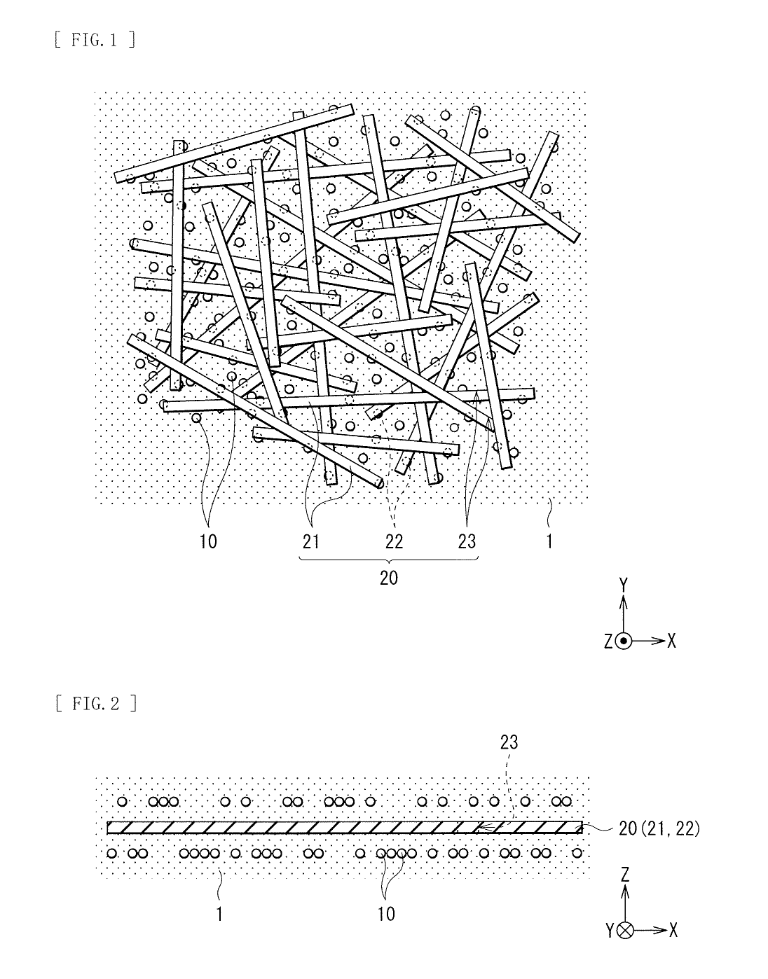

FIG. 1 and FIG. 2 respectively illustrate a plane configuration and a cross-sectional configuration in an electrophoretic element according to an embodiment of the present technology. The electrophoretic element generates contrast by utilizing electrophoretic phenomenon, and may be applied to various electronic apparatuses such as a display unit. The electrophoretic element includes a plurality of electrophoretic particles 10 having polarity and a porous layer 20 in an insulating liquid 1. In this embodiment, the electrophoretic particles 10 and the porous layer 20 have the same charging polarity.

1-1. Whole Configuration

### [Insulating Liquid]

The insulating liquid 1 may include, for example, one or more types of organic solvents, and may be specifically paraffin, isoparaffin, or the like. The viscosity and the refractive index of the insulating liquid 1 may be preferably small as much as possible. Thereby, in this case, mobility (response speed) of the electrophoretic particles 10 is improved, and accordingly, energy (power consumption) necessary to move the electrophoretic particles 10 is decreased. Also, in this case, since a difference between the refractive index of the insulating liquid 1 and the refractive index of the porous layer 20 is increased, reflectance of the porous layer 20 is increased.

It is to be noted that the insulating liquid 1 may contain various materials as necessary. Examples of the various materials may include a colorant, a charge-controlling agent, a dispersion stabilizer, a viscosity modifier, a surfactant, and a resin.

[Electrophoretic Particles]

The electrophoretic particles 10 are charged particles that are dispersed in the insulating liquid 1 and are positively (+)-charged or negatively (−)-charged. The electrophoretic particles 10 are movable through the porous layer 20 according to an electric field. The electrophoretic particles 10 may include, for example, one or more types of particles (powder) of a material such as an organic pigment, an inorganic pigment, a dye, a carbon material, a metal material, a metal oxide, glass, and a polymer material (a resin). Further, the electrophoretic particle 10 may be a crushed particle, a capsule particle, or the like of a resin solid content containing the foregoing particles. It is to be noted that materials corresponding to the carbon material, the metal material, the metal oxide, the glass, or the polymer material are excluded from materials corresponding to the organic pigment, the inorganic pigment, or the dye.

Examples of the organic pigment may include an azo pigment, a metal complex azo pigment, a poly-condensed azo pigment, a flavanthrone pigment, a benzimidazolone pigment, a phthalocyanine pigment, a quinacridone pigment, an anthraquinone pigment, a perylene pigment, a perinone pigment, an anthrapyridine pigment, a piranthrone pigment, a dioxazine pigment, a thioindigo pigment, an isoindolinone pigment, a quinophthalone pigment, and an indanthrene pigment. Examples of the inorganic pigment may include zinc oxide, antimony trioxide, carbon black, iron black, titanium boride, colcothar, mapico yellow, minium, cadmium yellow, zinc sulfide, lithopone, barium sulfide, cadmium selenide, calcium carbonate, barium sulfate, lead chromate, lead sulfate, barium carbonate, white lead, and alumina white. Examples of the dye may include a nigrosine dye, an azo dye, a phthalocyanine dye, a quinophthalone dye, an anthraquinone dye, and a methine dye. Examples of the carbon material may include carbon black. Examples of the metal material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a polymer compound in which a functional group having a light absorption region in a visible light region is introduced. As long as such a polymer compound having the light absorption region in the visible light region is used, the type thereof is not particularly limited.

The content (concentration) of the electrophoretic particles 10 in the insulating liquid 1 is not particularly limited, and may be preferably, for example, from 0.1 wt % to 10 wt % both inclusive, since thereby, shielding characteristics and mobility of the electrophoretic particles 10 are secured. In this case, if the content (concentration) of the electrophoretic particles 10 in the insulating liquid 1 is smaller than 0.1 wt %, the electrophoretic particles 10 may be less likely to shield (mask) the porous layer 20. On the other hand, if the content (concentration) of the electrophoretic particles 10 in the insulating liquid 1 is larger than 10 wt %, dispersibility of the electrophoretic particles 10 is lowered, and therefore, the electrophoretic particles 10 may be less likely to be electrophoresed, and may be aggregated in some cases.

The electrophoretic particles 10 have any optical reflection characteristics (reflectance). Although the optical reflection characteristics of the electrophoretic particles 10 are not particularly limited, at least, it may be preferable that the electrophoretic particles 10 be allowed to shield the porous layer 20. One reason for this is that, by using a difference between the optical reflection characteristics of the electrophoretic particles 10 and the optical reflection characteristics of the porous layer 20, contrast is generated.

Specific formation materials of the electrophoretic particles 10 are selected according to a role undertaken by the electrophoretic particles 10 to generate contrast. Specifically, a material in the case of performing light display by the electrophoretic particles 10 may be, for example, a metal oxide such as titanium oxide, zinc oxide, zirconium oxide, barium titanate, and potassium titanate. On the other hand, a material in the case of performing dark display by the electrophoretic particles 10 may be, for example, a carbon material, a metal oxide, or the like. Examples of the carbon material may include carbon black. Examples of the metal oxide may include copper-chromium oxide, copper-manganese oxide, copper-iron-manganese oxide, copper-chromium-manganese oxide, and copper-iron-chromium oxide. In particular, the carbon material may be preferable, since thereby, superior chemical stability, superior mobility, and superior light absorption are obtainable.

In the case of performing the light display by the electrophoretic particles 10, a color of the electrophoretic particles 10 viewed when the electrophoretic element is seen from outside is not particularly limited as long as contrast is allowed to be thereby generated. However, in particular, the color of the electrophoretic particles 10 in this case may be preferably a color close to white, and may be more preferably white. On the other hand, in the case of performing the dark display by the electrophoretic particles 10, the color of the electrophoretic particles 10 viewed when the electrophoretic element is seen from outside is not particularly limited as long as contrast is allowed to be thereby generated. However, in particular, the color of the electrophoretic particles 10 in this case may be preferably a color close to black, and may be more preferably black. One reason is that, in both cases, high contrast is obtainable.

It may be preferable that the electrophoretic particles 10 be easily dispersed and be easily charged in the insulating liquid 1 for a long time, and be less likely to be absorbed into the porous layer 20. Therefore, for the electrophoretic particles 10 in this embodiment, a material having the same charging polarity as that of the porous layer 20 is selected. Alternatively, the electrophoretic particles 10 are subject to surface treatment so that the electrophoretic particles 10 are charged to have the same polarity as that of the porous layer 20. Specifically, in the case where the porous layer 20 has negative charging polarity, the surface of the electrophoretic particles 10 is modified by a functional group having negative electric charge such as electron absorption. On the other hand, in the case where the porous layer 20 has positive charging polarity, the surface of the electrophoretic particles 10 is modified by a functional group having positive electric charge such as electron donation. Thereby, electrostatic repulsion occurs between the electrophoretic particles 10 and the porous layer 20, and absorption between the electrophoretic particles 10 and the porous layer 20 and aggregation of the electrophoretic particles 10 are suppressed. It is to be noted that the functional group modifying the surface of the electrophoretic particles 10 is not limited to the same functional group, and different functional groups may be introduced, as long as the electrophoretic particles 10 and the porous layer 20 show electric charge in the same direction (positive or negative). Alternatively, a disperser such as an electric charge adjuster may be used instead of surface treatment, or both the foregoing methods may be used.

Examples of the disperser may include Solsperse series available from Lubrizol Co., BYK series or Anti-Terra series available from BYK-Chemie Co., and Span series available from ICI Americas Co.

Examples of the surface treatment may include rosin treatment, surfactant treatment, pigment derivative treatment, coupling agent treatment, graft polymerization treatment, and microcapsulation treatment. In particular, the coupling agent treatment, the graft polymerization treatment, the microcapsulation treatment, or a combination thereof may be preferable, since thereby, dispersion stability and the like are obtainable for a long time.

Examples of a material for the surface treatment may include a material (absorptive material) having a functional group capable of being absorbed into the surface of the electrophoretic particles 10 and a polymerizable functional group. Absorbable functional group type is determined according to the formation material of the electrophoretic particles 10. Examples thereof may include an aniline derivative such as 4-vinylaniline for a carbon material such as carbon black and an organosilane derivative such as methacrylic acid 3-(trimethoxysilyl)propyl for a metal oxide. Examples of the polymerizable functional group may include a vinyl group, an acryl group, and a methacryl group.

Further, examples of the material for the surface treatment may include a material (graft material) capable of being grafted into the surface of the electrophoretic particles 10 to which a polymerizable functional group is introduced. The graft material may preferably have a polymerizable functional group and a dispersion functional group capable of dispersing in the insulating liquid 1 and capable of retaining dispersibility by steric barrier. A type of polymerizable functional group is similar to that described for the absorptive material. Examples of the dispersion functional group may include a branch-like alkyl group in the case where the insulating liquid 1 is paraffin. To polymerize or graft the graft material, for example, a polymerization initiator such as azobisisobutyronitrile (AIBN) may be used.

For reference, for details of a method of dispersing the electrophoretic particles 10 in the insulating liquid 1 as described above, description is given in books such as “Dispersion Technology of Superfine Particle and Evaluation thereof: Surface Treatment, Pulverizing, and Dispersion Stabilization in Air/Liquid/Polymer” published by Science & Technology Co.

[Porous Layer]

The porous layer 20 is a three-dimensional space structure configured of a fibrous structure 21, and has a plurality of fine pores 23 formed by the three-dimensional space structure. The fibrous structure 21 includes a plurality of non-electrophoretic particles 22. The plurality of non-electrophoretic particles 22 are supported by the fibrous structure 21. The porous layer 20 has one of positive polarity and negative polarity by one or both of the fibrous structure 21 and the non-electrophoretic particles 22. In the electrophoretic element in this embodiment, the electrophoretic particles 10 and the porous layer 20 have the same electric charge. Upon preparing the respective electric charges, as described above, the charging polarity of the electrophoretic particles 10 may be preferably the same as the charging polarity of the porous layer 20. One reason for this is that, in this case, lowered characteristics resulting from change of the pore diameter of the fine pore 23 and change of light reflection characteristics by modification of the porous layer 20 is prevented.

In the porous layer 20 as the three-dimensional space structure, one fibrous structure 21 may be intertwined at random, a plurality of fibrous structures 21 may assemble and be layered at random, or both the foregoing states may exist at once. In the case where the plurality of fibrous structures 21 exist, the respective fibrous structures 21 support one or two or more non-electrophoretic particles 22. It is to be noted that FIG. 1 illustrates a case that the porous layer 20 is formed of the plurality of fibrous structures 21.

One reason why the porous layer 20 is the three-dimensional space structure formed of the fibrous structure 21 is that, in this case, light (outside light) is reflected diffusely (multiply scattered), and therefore, the reflectance of the porous layer 20 is increased, and the thickness of the porous layer 20 is allowed to be decreased in order to obtain such increased reflectance. Thereby, contrast of the electrophoretic element is increased, and energy necessary to move the electrophoretic particles 10 is decreased. Further, since the average pore diameter of the fine pores 23 is increased, and the number thereof is increased, the electrophoretic particles 10 are easily moved through the fine pores 23. Thereby, response speed is increased, and energy necessary to move the electrophoretic particles 10 is further decreased.

The fibrous structure 21 is a fibrous material having a sufficiently large length with respect to the fibrous diameter (diameter). The fibrous structure 21 may include, for example, one or two or more types of polymer materials, inorganic materials, and the like, and may be formed of other materials. Examples of the polymer material may include nylon, polylactic acid, polyamide, polyimide, polyethylene terephthalate, polyacrylonitrile (PAN), polyethylene oxide, polyvinyl carbazole, polyvinyl chloride, polyurethane, polystyrene, polyvinyl alcohol, polysulfone, polyvinyl pyrrolidone, polyvinylidene fluoride, polyhexafluoropropylene, acetylcellulose, collagen, gelatin, chitosan, and copolymers thereof. Examples of the inorganic material may include titanium oxide. In particular, as a formation material of the fibrous structure 21, the polymer material may be preferable. Since the polymer material has low reactivity (photoreactivity or the like), that is, the polymer material is chemically stable, unintended decomposition reaction of the fibrous structure 21 is thereby suppressed. It is to be noted that, in the case where the fibrous structure 21 is formed of a material with high reactivity, the surface of the fibrous structure 21 may be preferably covered with any protective layer (not illustrated).

The shape (appearance) of the fibrous structure 21 is not particularly limited as long as the fibrous structure 21 is a fiber having a sufficiently large length with respect to the fiber diameter as described above. Specifically, the shape (appearance) thereof may be linear, may be curly, or may be bent on the way. Further, the fibrous structure 21 may be extended in one direction, or may be branched into two or more directions on the way. A method of forming the fibrous structure 21 is not particularly limited. The method of forming the fibrous structure 21 may be preferably, for example, a phase separation method, a phase reverse method, an electrostatic (electric field) spinning method, a melt spinning method, a wet spinning method, a dry spinning method, a gel spinning method, a sol gel method, a spray coating method, or the like, since a fibrous material having a sufficiently large length with respect to the fiber diameter is easily and stably formed by the foregoing methods.

Although the fiber diameter of the fibrous structure 21 is not particularly limited, the fiber diameter thereof is preferably small as much as possible. One reason for this is that, in this case, light becomes easily reflected diffusely, and the pore diameter of the fine pore 23 becomes larger. However, it may be desirable to determine the fiber diameter of the fibrous structure 21 so that the fibrous structure 21 is allowed to support the after-mentioned non-electrophoretic particles 22. Therefore, the fiber diameter of the fibrous structure 21 may be preferably from 50 nm to 2000 nm both inclusive, and the average fiber diameter thereof may be preferably equal to or less than 10 μm. It is to be noted that the lower limit of the average fiber diameter is not particularly limited, and may be, for example, equal to or less than 0.1 μm. The fiber diameter and the average fiber diameter may be, for example, measured by microscope observation with the use of a scanning electron microscope or the like. It is to be noted that the average length of the fibrous structure 21 may be set optionally.

In particular, the fibrous structure 21 may be preferably a nanofiber. One reason for this is that, in this case, light becomes easily reflected diffusely, and therefore, the reflectance of the porous layer 20 is further increased. Another reason for this is that, in this case, a rate of the fine pores 33 per unit volume is increased, and therefore, the electrophoretic particles 10 easily move through the fine pores 23. Thereby, contrast is further increased, and the energy necessary to move the electrophoretic particles 10 is further decreased. The nanofiber is a fibrous material having a fiber diameter being from 0.001 μm to 0.1 μm both inclusive and having a length being 100 times or more the fiber diameter. The fibrous structure 21 as the nanofiber may be preferably formed by an electrostatic spinning method, since thereby, the fibrous structure 21 having a small fiber diameter is easily and stably formed.

The fibrous structure 21 may preferably have optical reflection characteristics different from those of the electrophoretic particles 10. Specifically, although the optical reflection characteristics of the fibrous structure 21 are not particularly limited, the optical reflection characteristics thereof may be preferably set at least so that the porous layer 20 is allowed to shield the electrophoretic particles 10 as a whole. One reason for this is that, as described above, in this case, by using the difference between the optical reflection characteristics of the electrophoretic particles 10 and the optical reflection characteristics of the porous layer 20, contrast is allowed to be generated. Therefore, the fibrous structure 21 having light transparency (transparent and colorless characteristics) in the insulating liquid 1 may not be preferable. However, in the case where the optical reflection characteristics of the fibrous structure 21A are less likely to affect the optical reflection characteristics of the porous layer 20, and the optical reflection characteristics of the porous layer 20 are substantially determined by the optical reflection characteristics of the non-electrophoretic particles 22, the optical reflection characteristics of the fibrous structure 21 may be set optionally.

Although the average pore diameter of the fine pores 23 is not particularly limited, the average pore diameter thereof may be preferably large as much as possible, since the electrophoretic particles 21 easily move through the fine pores 23 thereby. Therefore, the average pore diameter of the fine pores 23 may be preferably from 0.01 μm to 10 μm both inclusive.

The thickness of the porous layer 20 is not particularly limited, and may be, for example, from 5 μm to 100 μm both inclusive, since shielding characteristics of the porous layer 20 are increased thereby, and the electrophoretic particles 10 easily move through the fine pores 23.

The non-electrophoretic particles 22 are supported by (fixed to) the fibrous structure 21, and are particles that are not electrophoresed. Since the fibrous structure 21 contains the plurality of non-electrophoretic particles 22, light is further easily reflected diffusely, and contrast of the electrophoretic element is further increased. It is to be noted that the non-electrophoretic particles 22 may be partially exposed from the fibrous structure 21, or may be buried in the fibrous structure 21, as long as the non-electrophoretic particles 22 are supported by the fibrous structure 21.

The non-electrophoretic particles 22 have optical reflection characteristics different from those of the electrophoretic particles 10. Although the optical reflection characteristics of the non-electrophoretic particles 22 are not particularly limited, it may be preferable that at least the porous layer 20 be allowed to shield the electrophoretic particles 10 as a whole. One reason for this is that, as described above, by using the difference between the optical reflection characteristics of the electrophoretic particles 10 and the optical reflection characteristics of the porous layer 20, contrast is allowed to be generated. It is to be noted that in this embodiment, light reflectance of the non-electrophoretic particles 22 is higher than that of the electrophoretic particles 10.

The formation material of the non-electrophoretic particles 22 is selected according to the role undertaken by the non-electrophoretic particles 22 for generating contrast. Specifically, a material in the case of performing the light display by the non-electrophoretic particles 22 is similar to the material selected in the case of performing the light display by the electrophoretic particles 10. On the other hand, a material in the case of performing the dark display by the non-electrophoretic particles 22 is similar to the material selected in the case of performing the dark display by the electrophoretic particles 10. In particular, as the material selected in the case of performing the light display by the non-electrophoretic particles 22, a metal oxide may be preferable, since thereby, superior chemical stability, superior fixing characteristics, and superior light reflectance are obtainable. The formation material of the non-electrophoretic particles 22 may be the same type as that of the formation material of the electrophoretic particles 10, or may be different type from that of the formation material of the electrophoretic particles 10, as long as contrast is allowed to be thereby generated. It is to be noted that a color viewed in the case of performing the light display or the dark display by the non-electrophoretic particles 22 is similar to the case described for the viewed color of the electrophoretic particles 10.

1-2. Method of Preparing Electrophoretic Particles

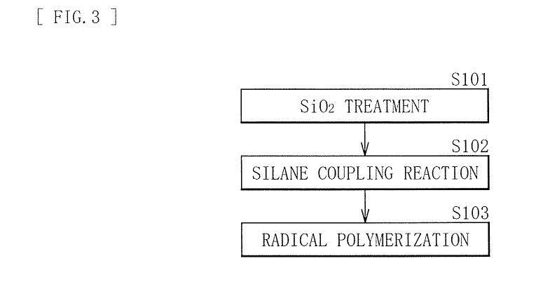

An example of a method of preparing the electrophoretic particles 10 is as follows. FIG. 3 illustrates a flow of a preparation procedure of the electrophoretic particles 10. First, for example, as step S101, sodium hydroxide and sodium silicate may be dissolved in water to prepare a solution A. Subsequently, for example, composite oxide fine particles (DAIPYROXIDE Color™ 3550, available from Dainichiseika Color & Chemicals Mfg. Co., Ltd.) may be added to the solution A, the resultant is heated, and thereafter, for example, 1 mol/cm³ of sulfuric acid and an aqueous solution in which sodium silicate and sodium hydroxide are dissolved may be dropped therein. Next, for example, as step S102, a mixed solution of ethanol and water may be added to the resultant to obtain a dispersion solution of silane-coated composite oxide particles. Subsequently, for example, water, ethanol, and allyltriethoxysilane may be mixed, and thereafter, the resultant mixture is added with the foregoing dispersion solution to prepare a mixed solution. Next, the mixed solution is subject to post treatment to obtain a solid material. The solid material may be added with, for example, toluene, and the resultant is stirred to prepare a solution B. Subsequently, as step S103, for example, acrylic acid and 2,5-dimethyl-1,5-hexadiene may be added to the solution B, and subsequently, the resultant is stirred under nitrogen stream. Next, the solution B may be mixed with a solution C in which, for example, 2,2′-azobis(2-methyl)propionitril(azobisisobutyronitrile; AIBN) is dissolved in toluene, and thereby, a polymerization reaction of the electrophoretic particles 10 is initiated. Thereby, the black electrophoretic particles 10 made of a polymer-coated pigment are obtained.

[Preferable Display Method of Electrophoretic Element]

In the electrophoretic element, as described above, the electrophoretic particles 10 and the porous layer 20 (the fibrous structure 21 containing the non-electrophoretic particles 22) respectively perform the light display and the dark display, and therefore, contrast is generated. In this case, the light display may be performed by the electrophoretic particles 10 and the dark display may be performed by the porous layer 20, or vice versa. Such a difference in roles is determined by relation between the optical reflection characteristics of the electrophoretic particles 10 and the optical reflection characteristics of the porous layer 20. That is, the reflectance in the case of the light display is higher than the reflectance in the case of the dark display.

In particular, it may be preferable that the dark display be performed by the electrophoretic particles 10 and the light display be performed by the porous layer 20. Accordingly, in the case where the optical characteristics of the porous layer 20 are substantially determined by the optical reflection characteristics of the non-electrophoretic particles 22, the reflectance of the non-electrophoretic particles 22 may be preferably higher than the reflectance of the electrophoretic particles 10. One reason is that the reflectance for the light display in this case becomes significantly increased by utilizing diffuse reflection of light by the porous layer 20 (three-dimensional space structure), and therefore, contrast becomes significantly increased accordingly.

[Operation of Electrophoretic Element]

In the electrophoretic element, the optical reflection characteristics of the electrophoretic particles 10 are different from the optical reflection characteristics of the porous layer 20 (the non-electrophoretic particles 22). In this case, in the case where an electric field is applied to the electrophoretic element, the electrophoretic particles 10 are moved through the porous layer 20 (the fine pores 23) in a range in which the electric field is applied. Thereby, when the electrophoretic element is viewed from the side on which the electrophoretic particles 10 are moved, the dark display (or the light display) is performed by the electrophoretic particles 10 in a range in which the electrophoretic particles 10 are moved, and the light display (or the dark display) is performed by the porous layer 20 in a range in which the electrophoretic particles 10 are not moved. Thereby, contrast is generated.

In an electrophoretic element, electric charge is applied to electrophoretic particles by surface treatment so that the electrophoretic particles are not aggregated, and as a fibrous structure, a polymer that is less likely to chemically interact with the electrophoretic particles is mainly used. Specifically, the electrophoretic particles are subject to surface treatment to add acceptor characteristics, each SP (Solubility Parameter) value on each surface is set to a value in a certain range, and a polymer having weak donor characteristics is used as a material of the fibrous structure. By adopting such a structure, the electrophoretic particles migrate without being tangled by the fibrous structure. However, there has been a disadvantage that since the fibrous structure has the weak donor characteristics, the fibrous structure absorbs the electrophoretic particles and a disperser to lower display characteristics.

[Function and Effect]

On the contrary, according to this embodiment, the electric charge of the electrophoretic particles 10 and the electric charge of the porous layer 20 have the same charging polarity. Specifically, a functional group is introduced to the electrophoretic particles 10 so that the electrophoretic particles 10 and the porous layer 20 have the same electric charge. Thereby, in the case where the electrophoretic particles 10 are moved through the fine pores 23 formed by the fibrous structure 21, the electrophoretic particles 10 are prevented from being absorbed into wall surfaces of the fine pores 23. Therefore, reflection characteristics in the light display and the dark display of the electrophoretic element are improved, and contrast is improved.

### 2. Application Example of Electrophoretic Element

Next, a description will be given of an application example of the foregoing electrophoretic element. The electrophoretic element is applicable to various electronic apparatuses, and types of the electronic apparatuses are not particularly limited. For example, the electrophoretic element may be applied to a display unit.

[Whole Configuration of Display Unit]

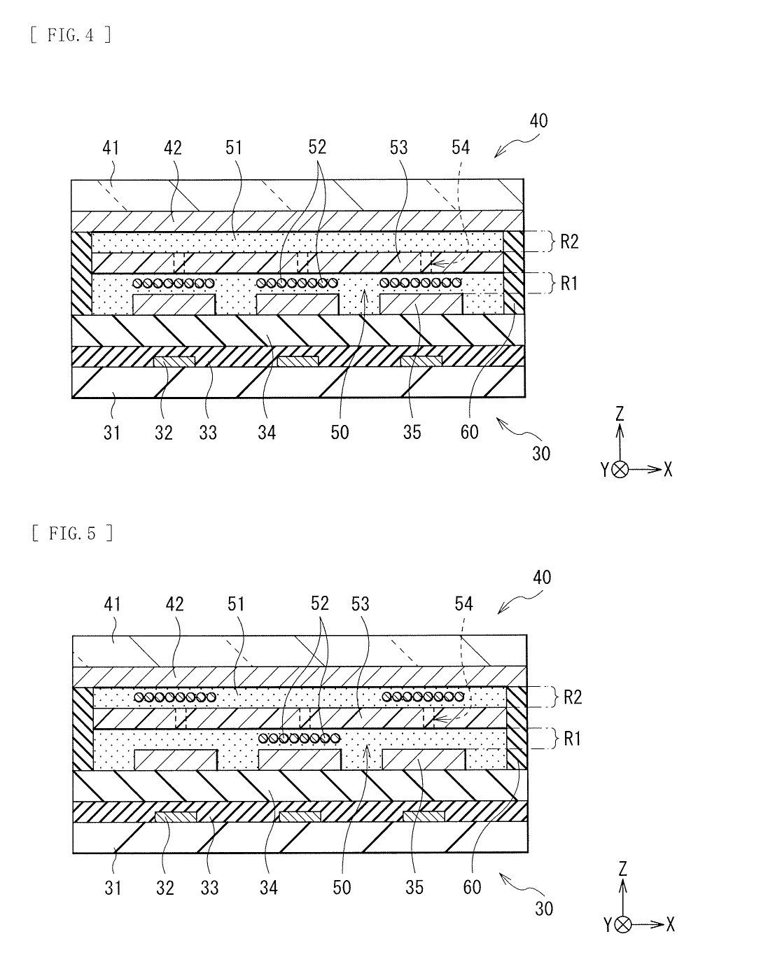

FIG. 4 illustrates a cross-sectional configuration of a display unit. FIG. 5 is a view for explaining operation of the display unit illustrated in FIG. 4. It is to be noted that the configuration of the display unit described below is merely an example, and may be changed as appropriate.

The display unit is an electrophoretic display (a so-called electronic paper display) for displaying an image (such as textual information) utilizing electrophoretic phenomenon. In the display unit, for example, as illustrated in FIG. 4, a drive substrate 30 and an opposed substrate 40 may be arranged to oppose each other with an electrophoretic element 50 in between. For example, in the display unit, an image may be displayed on the opposed substrate 40 side. It is to be noted that the drive substrate 30 and the opposed substrate 40 are separated by a spacer 60 at a prescribed interval.

[Drive Substrate]

In the drive substrate 30, for example, a plurality of thin film transistors (TFT) 32, a protective layer 33, a planarizing insulating layer 34, and a plurality of pixel electrodes 35 may be formed in this order over one surface of a support base substance 31. The TFT 32 and the pixel electrode 35 are arranged in a state of matrix or in a state of segment according to a pixel arrangement.

The support base substance 31 may be formed, for example, of an inorganic material, a metal material, a plastic material, or the like. Examples of the inorganic material may include silicon (Si), silicon oxide (SiOₓ), silicon nitride (SiNₓ), and aluminum oxide (AlOₓ). Examples of the silicon oxide may include glass and spin-on glass (SOG). Examples of the metal material may include aluminum (Al), nickel (Ni), and stainless steel. Examples of the plastic material may include polycarbonate (PC), polyethylene terephthalate (PET), polyethylene naphthalate (PEN), and polyethyl ether ketone (PEEK).

The support base substance 31 may be of a light transmissive type or a non-light transmissive type. One reason is that, since an image is displayed on the opposed substrate 40 side, the support base substance 31 is not necessarily of a light transmissive type. Further, the support base substance 31 may be a substrate having rigidity such as a wafer, or may be a thin layer glass, a film, or the like having flexibility. In particular, the latter type is preferable, since thereby, a flexible (bendable) display unit is allowed to be achieved.

The TFT 32 is a switching-use element for selecting a pixel. It is to be noted that the TFT 32 may be an inorganic TFT using an inorganic semiconductor layer as a channel layer, or may be an organic TFT using an organic semiconductor layer. The protective layer 33 and the planarizing insulating layer 34 may be formed, for example, of an insulating resin material such as polyimide. However, as long as the surface of the protective layer 33 is sufficiently flat, the planarizing insulating layer 34 may be omitted. The pixel electrode 35 may be formed, for example, of a metal material such as gold (Au), silver (Ag), and copper (Cu). The pixel electrode 35 is connected to the TFT 32 through a contact hole (not illustrated) provided on the protective layer 33 and the planarizing insulating layer 34.

[Opposed Substrate]

In the opposed substrate 40, for example, a counter electrode 42 may be formed entirely over one surface of a support base substance 41. Alternatively, the counter electrode 42 may be arranged in a state of matrix or in a state of segment as the pixel electrode 32 may be.

The support base substance 41 is formed of a material similar to that of the support base substance 31, except that the support base substance 41 is of a light transmissive type. One reason is that, since an image is displayed on the opposed substrate 40 side, the support base substance 41 should be of a light transmissive type. The counter electrode 42 may be formed, for example, of a light transmissive conductive material (a transparent electrode material) such as indium oxide-tin oxide (ITO), antimony oxide-tin oxide (ATO), fluorine-doped tin oxide (FTO), and aluminum-doped zinc oxide (AZO).

In the case where an image is displayed on the opposed substrate 40 side, viewers view the electrophoretic element 50 through the counter electrode 42. Therefore, light transmission characteristics (transmittance) of the counter electrode 42 may be preferably high as much as possible, and may be, for example, equal to or higher than 80%. Further, electric resistance of the counter electrode 42 may be preferably low as much as possible, and for example, may be equal to or smaller than 100 Ω/□.

[Electrophoretic Element]

The electrophoretic element 50 has a configuration similar to that of the foregoing electrophoretic element. Specifically, the electrophoretic element 50 includes a plurality of electrophoretic particles 52 and a porous layer 53 having a plurality of fine pores 54 in an insulating liquid 51. The insulating liquid 51 is filled in a space between the drive substrate 30 and the opposed substrate 40. For example, the porous layer 53 may be supported by a spacer 60. The space filled with the insulating liquid 51 is divided into a refuge region R1 on the side close to the pixel electrode 35 and a movement region R2 on the side close to the counter electrode 42 with the porous layer 53 in between as a boundary. Configurations of the insulating liquid 51, the electrophoretic particles 52, and the porous layer 53 are respectively similar to the configurations of the insulating liquid 1, the electrophoretic particles 10, and the porous layer 20. It is to be noted that FIG. 4 and FIG. 5 illustrate only part of the fine pores 54 to simplify illustrated content.

[Spacer]

The spacer 60 may be formed, for example, of an insulating material such as a polymer material.

Although a shape of the spacer 60 is not particularly limited, in particular, the shape of the spacer 60 may be preferably a shape that does not prevent movement of the electrophoretic particles 52 and is allowed to uniformly distribute the electrophoretic particles 52. For example, the shape of the spacer 60 may be a lattice-like shape. Further, although the thickness of the spacer 60 is not particularly limited, the thickness of the spacer 60 may be preferably small as much as possible in order to decrease power consumption, and may be, for example, from 10 μm to 100 μm both inclusive.

[Operation of Display Unit]

In the display unit, as illustrated in FIG. 4, in an initial state, the plurality of electrophoretic particles 52 are located in the refuge region R1. In this case, the electrophoretic particles 52 are shielded by the porous layer 53 in all pixels, and therefore, contrast is not generated (an image is not displayed) in the case where the electrophoretic element 50 is viewed from the opposed substrate 40 side.

In the case where a pixel is selected by the TFT 32 and an electric field is applied between the pixel electrode 35 and the counter electrode 42, as illustrated in FIG. 5, the electrophoretic particles 52 are moved from the refuge region R1 toward the movement region R2 thorough the porous layer 53 (the fine pores 54). In this case, since pixels in which the electrophoretic particles 52 are shielded by the porous layer 53 and pixels in which the electrophoretic particles 52 are not shielded by the porous layer 53 coexist, contrast is generated when the electrophoretic element 50 is viewed from the opposed substrate 40 side. Thereby, an image is displayed.

[Function and Effect of Display Unit]

According to the display unit, the electrophoretic element 50 has a configuration similar to that of the foregoing electrophoretic element. Therefore, optical characteristics in light display and dark display of the electrophoretic element are improved, and contrast is improved. Accordingly, a high-quality display unit with improved display characteristics is allowed to be provided.

### 3. Examples

Next, a description will be given in detail of examples of the present technology.

### Experimental Example 1

A display unit was fabricated with the use of black electrophoretic particles 10 (for dark display) and a white porous layer 20 (a particle-containing fibrous structure) (for light display) by the following procedure. It is to be noted that both the electrophoretic particles 10 and the porous layer 20 in Experimental Example 1 were prepared to have negative electric charge.

[Preparation of Electrophoretic Particles]

First, 43 g of sodium hydroxide and 0.37 g of sodium silicate were dissolved in 43 g of water to obtain a solution A. Subsequently, 5 g of composite oxide fine particles (DAIPYROXIDE Color™ 3550, available from Dainichiseika Color & Chemicals Mfg. Co., Ltd.) were added to the solution A while the solution A was stirred, and the resultant was stirred (for 15 minutes). Thereafter, ultrasonic stirring (for 15 minutes at from 30 deg C. to 35 deg C. both inclusive) was performed. Next, the solution A was heated (at 90 deg C.). Thereafter, 15 cm³ (=ml) of vitriolic acid (0.22 mol/cm³) and 7.5 cm³ of an aqueous solution in which 6.5 mg of sodium silicate and 1.3 mg of sodium hydroxide were dissolved were dropped for 2 hours. Subsequently, after the solution A was cooled down (to room temperature), 1.8 cm³ of vitriolic acid (1 mol/cm³) was added thereto. Thereafter, centrifugal separation (for 30 minutes at 3700 rpm) and decantation were performed. Next, redispersion was performed with the use of ethanol, and centrifugal separation (for 30 minutes at 3500 rpm) and decantation were further performed twice. Thereafter, a mixed solution of 5 cm³ of ethanol and 0.5 cm³ of water was added to each bottle, ultrasonic stirring (for 1 hour) was performed, and thereby, a dispersion solution configured of silane coated composite oxide particles was obtained.

Next, 3 cm³ of water, 30 cm³ of ethanol, and 2 g of allyltriethoxysilane were mixed, and the mixture was stirred (for 7 minutes). Thereafter, the resultant mixed solution was mixed with a full amount of the dispersion solution. Subsequently, the mixed solution was stirred (for 10 minutes), and thereafter, was subjected to centrifugal separation (for 30 minutes at 3500 rpm). Next, after decantation was performed, as washing operation, redispersion with the use of ethanol and centrifugal separation (for 30 minutes at 3500 rpm) were performed twice. After performing decantation, the resultant was dried (for 6 hours) in reduced pressure environment (at room temperature), and the resultant was dried (for 2 hours) in reduced pressure environment (at 70 deg C.) to obtain a solid material. Subsequently, the solid material was added with 50 cm³ of toluene to obtain the solution B. Thereafter, the resultant was stirred by a roll mill (for 12 hours). Next, the solution B was transferred to a three-necked flask, and was added with 0.5 g of acrylic acid and 2.0 g of 2,5-dimethyl-1,5-hexadiene, and the resultant was stirred under nitrogen gas stream (for 20 minutes). Next, the solution B was further stirred (at 50 deg C. for 20 minutes). Thereafter, the solution B was added with a solution C in which 0.01 g of AIBN was dissolved in 3 cm³ of toluene, and was heated (at 65 deg C.). Subsequently, the mixed solution was stirred (for one hour), was cooled down (to room temperature), and was run into a bottle together with ethyl acetate. Thereafter, centrifugal separation (for 30 minutes at 3500 rpm) was performed. Next, after decantation was performed, as washing operation, redispersion with the use of ethyl acetate and centrifugal separation (for 30 minutes at 3500 rpm) were performed three times. Subsequently, after the resultant was dried (for 12 hours) in reduced pressure environment (at room temperature), the resultant was further dried in reduced pressure environment (at 70 deg C.) (for 2 hours). Thereby, black electrophoretic particles configured of a polymer coated pigment were obtained.

[Preparation of Insulating Liquid]

Next, as an insulating liquid, an organic solvent containing 5.0% of OLOA1200 (available from Chevron), 1.0% of 2,5-hexanedione, and 94% of isoparaffin (IsoparG, available from Exxon Mobil Corporation) was prepared. In this case, as necessary, 0.2 g of the electrophoretic particles were added to 9.7 g of the insulating liquid, and the resultant was stirred (for one hour) by a beads mill added with glass beads (0.8 mm φ). Subsequently, the mixed solution was subjected to a glass fiber filter to remove the beads. Thereby, an insulating liquid in which the electrophoretic particles were dispersed was obtained.

[Preparation of Porous Layer]

Next, 12 g of polyacrylonitrile (available from Aldrich Co., molar weight: 150000) as a formation material of a fibrous structure was dissolved in 88 g of DMF to prepare a solution D. Subsequently, as non-electrophoretic particles, for example, 40 g of titanium oxide (TITONE R-42 available from Sakai Chemical Industry Co., Ltd.) was added to 60 g of the solution D, and thereafter, the resultant was mixed by a beads mill to obtain a spinning solution. Subsequently, the spinning solution was thrown in a syringe, and 8 round trips of spinning were performed with the use of an electric field spinning apparatus (NANON, available from MECC Co., Ltd.) on a glass substrate on which pixel electrodes (ITO) in the shape of a predetermined pattern were formed. As spinning conditions, electric field intensity was 28 kV, discharge rate was 0.5 cm³/min, spinning distance was 15 cm, and scanning rate was 20 mm/sec. Next, the glass substrate was dried for 12 hours in a vacuum oven (at 75 deg C.) to form a fibrous structure containing non-electrophoretic particles.

[Assembly of Display Unit]

An unnecessary fibrous structure attached to a region where the pixel electrodes were not formed was removed from a glass substrate on which the pixel electrodes were formed. Thereafter, a PET film (being 30 μm thick) as a spacer was laid on a glass substrate on which the counter electrode (ITO) was entirely formed. The glass substrate over which the pixel electrodes and the fibrous structure were formed was layered on the spacer. It is to be noted that tracing was made with the use of a light cured resin (photosensitive resin Photolec A-400, available from Sekisui Chemical Co., Ltd.) containing beads (outer diameter: 30 μm) in location on which the porous layer was not layered. Finally, the insulating liquid in which the electrophoretic particles were dispersed was injected in a space between the two glass substrates. Thereafter, after the porous layer was set adjacent to the pixel electrodes and the counter electrode by pressing the entire body with a roller, the entire body was pressed again to compress the porous layer.

### Experimental Example 2

In Experimental Example 2, the electrophoretic particles 10 were positively charged, and the porous layer 20 was negatively charged. In Experimental Example 2, a display unit was fabricated by a procedure similar to that of the foregoing Experimental Example 1, except for preparation of electrophoretic particles and preparation of an insulating liquid.

[Preparation of Electrophoretic Particles]

First, 43 g of sodium hydroxide and 0.37 g of sodium silicate were dissolved in 43 g of water to obtain the solution A. Subsequently, 5 g of composite oxide fine particles (DAIPYROXIDE Color™ 3550, available from Dainichiseika Color & Chemicals Mfg. Co., Ltd.) were added to the solution A while the solution A was stirred, and the resultant was stirred (for 15 minutes). Thereafter, ultrasonic stirring (for 15 minutes at from 30 deg C. to 35 deg C. both inclusive) was performed. Next, the solution A was heated (at 90 deg C.). Thereafter, 15 cm³ (=ml) of vitriolic acid (0.22 mol/cm³) and 7.5 cm³ of an aqueous solution in which 6.5 mg of sodium silicate and 1.3 mg of sodium hydroxide were dissolved were dropped for 2 hours. Subsequently, after the solution A was cooled down (to room temperature), 1.8 cm³ of vitriolic acid (1 mol/cm³) was added thereto. Thereafter, centrifugal separation (for 30 minutes at 3700 rpm) and decantation were performed. Next, redispersion was performed with the use of ethanol, and centrifugal separation (for 30 minutes at 3500 rpm) and decantation were further performed twice. Thereafter, a mixed solution of 5 cm³ of ethanol and 0.5 cm³ of water was added to each bottle, ultrasonic stirring (for 1 hour) was performed, and thereby, a dispersion solution configured of silane coated composite oxide particles was obtained.

Next, 3 cm³ of water, 30 cm³ of ethanol, and 4 g of N-[3-(trimethoxysilyl)propyl]-N′-(4-vinylbenzil)ethylenediamine hydrochloride salt (40% methanol solution) were mixed, and the mixture was stirred (for 7 minutes). Thereafter, the resultant mixed solution was mixed with a full amount of the dispersion solution. Subsequently, the mixed solution was stirred (for 10 minutes), and thereafter, was subjected to centrifugal separation (for 30 minutes at 3500 rpm). Next, after decantation was performed, as washing operation, redispersion with the use of ethanol and centrifugal separation (for 30 minutes at 3500 rpm) were performed twice. After performing decantation, the resultant was dried (for 6 hours) in reduced pressure environment (at room temperature), and the resultant was dried (for 2 hours) in reduced pressure environment (70 deg C.) to obtain a solid material. Subsequently, the solid material was added with 50 cm³ of toluene to obtain the solution B. Thereafter, the resultant was stirred by a roll mill (for 12 hours). Next, the solution B was transferred to a three-necked flask, and was added with 0.5 g of acrylic acid and 2.0 g of 2,5-dimethyl-1,5-hexadiene, and the resultant was stirred under nitrogen gas stream (for 20 minutes). Next, the solution B was further stirred (at 50 deg C. for 20 minutes). Thereafter, the solution B was added with the solution C in which 0.01 g of AIBN was dissolved in 3 cm³ of toluene, and was heated (at 65 deg C.). Subsequently, the mixed solution was stirred (for one hour), was cooled down (to room temperature), and was run into a bottle together with ethyl acetate. Thereafter, centrifugal separation (for 30 minutes at 3500 rpm) was performed. Next, after decantation was performed, as washing operation, redispersion with the use of ethyl acetate and centrifugal separation (for 30 minutes at 3500 rpm) were performed three times. Subsequently, after the resultant was dried (for 12 hours) in reduced pressure environment (at room temperature), the resultant was further dried in reduced pressure environment (at 70 deg C) (for 2 hours). Thereby, black electrophoretic particles configured of a polymer coated pigment were obtained.

[Preparation of Insulating Liquid]

Next, as an insulating liquid, an organic solvent containing 0.75% of N,N-dimethylpropane-1,3-diamine, 12-hydroxy octadecanoic acid, and methoxysulfonyloxymethane (Solsperse 17000, available from Lubrizol Co.), 5.0% of Sorbitan Trioleate (Span 85), and 94% of an isoparaffin (IsoparG, available from Exxon Mobil Corporation) was prepared. In this case, as necessary, 0.2 g of the electrophoretic particles were added to 9.7 g of the insulating liquid, and the resultant was stirred (for one hour) by a beads mill added with glass beads (0.8 mm φ). Subsequently, the mixed solution was subjected to a glass fiber filter to remove the beads. Thereby, an insulating liquid in which the electrophoretic particles were dispersed was obtained.

### Experimental Example 3

In Experimental Example 3, a material negatively charged (composite oxide fine particles (DAIPYROXIDE Color™ 3550, available from Dainichiseika Color & Chemicals Mfg. Co., Ltd.)) was used as a material of the electrophoretic particles 10, surface treatment was not performed, and the electrophoretic particles 10 and the porous layer 20 were negatively charged. In Experimental Example 3, a display unit was fabricated by a procedure similar to that of the foregoing Experimental Example 1, except that surface treatment was not performed in preparation of the electrophoretic particles.

### Experimental Examples 4 and 5

In Experimental Examples 4 and 5, the electrophoretic particles 10 and the porous layer 20 were negatively charged. In Experimental Example 4 and 5, a display unit was fabricated by a procedure similar to that of the foregoing Experimental Example 1, except that a method of preparing electrophoretic particles, specifically, a method of surface treatment was different.

[Preparation of Electrophoretic Particles]

First, 43 g of sodium hydroxide and 0.37 g of sodium silicate were dissolved in 43 g of water to obtain the solution A. Subsequently, 5 g of composite oxide fine particles (DAIPYROXIDE Color™ 3550, available from Dainichiseika Color & Chemicals Mfg. Co., Ltd.) were added to the solution A while the solution A was stirred, and the resultant was stirred (for 15 minutes). Thereafter, ultrasonic stirring (for 15 minutes at from 30 deg C. to 35 deg C. both inclusive) was performed. Next, the solution A was heated (at 90 deg C.). Thereafter, 15 cm³ (=ml) of vitriolic acid (0.22 mol/cm³) and 7.5 cm³ of an aqueous solution in which 6.5 mg of sodium silicate and 1.3 mg of sodium hydroxide were dissolved were dropped for 2 hours. Subsequently, after the solution A was cooled down (to room temperature), 1.8 cm³ of vitriolic acid (1 mol/cm³) was added thereto. Thereafter, centrifugal separation (for 30 minutes at 3700 rpm) and decantation were performed. Next, redispersion was performed with the use of ethanol, and centrifugal separation (for 30 minutes at 3500 rpm) and decantation were further performed twice. Thereafter, a mixed solution of 5 cm³ of ethanol and 0.5 cm³ of water was added to each bottle, ultrasonic stirring (for 1 hour) was performed, and thereby, a dispersion solution configured of silane coated composite oxide particles was obtained.

Next, 3 cm³ of water, 30 cm³ of ethanol, and 2 g of 2-cyanoethyltriethoxysilane (Experimental Example 4) or 2 g of glycidoxypropyltrimethoxysilane (Experimental Example 5) were mixed, and the mixture was stirred (for 7 minutes). Thereafter, the resultant mixed solution was mixed with a full amount of the dispersion solution. Subsequently, the mixed solution was stirred (for 10 minutes), and thereafter, was subjected to centrifugal separation (for 30 minutes at 3500 rpm). Next, after decantation was performed, as washing operation, redispersion with the use of ethanol and centrifugal separation (for 30 minutes at 3500 rpm) were performed twice. After performing decantation, the resultant was dried (for 6 hours) in reduced pressure environment (at room temperature), and the resultant was dried (for 2 hours) in reduced pressure environment (70 deg C.) to obtain a solid material. Subsequently, the solid material was added with 50 m³ of toluene to obtain the solution B. Thereafter, the resultant was stirred by a roll mill (for 12 hours). Next, the solution B was transferred to a three-necked flask, and was added with 0.5 g of acrylic acid and 2.0 g of 2,5-dimethyl-1,5-hexadiene, and the resultant was stirred under nitrogen gas stream (for 20 minutes). Next, the solution B was further stirred (at 50 deg C. for 20 minutes). Thereafter, the solution B was added with the solution C in which 0.01 g of AIBN was dissolved in 3 cm³ of toluene, and was heated (at 65 deg C.). Subsequently, the mixed solution was stirred (for one hour), was cooled down (to room temperature), and was run into a bottle together with ethyl acetate. Thereafter, centrifugal separation (for 30 minutes at 3500 rpm) was performed. Next, after decantation was performed, as washing operation, redispersion with the use of ethyl acetate and centrifugal separation (for 30 minutes at 3500 rpm) were performed three times. Subsequently, after the resultant was dried (for 12 hours) in reduced pressure environment (at room temperature), the resultant was further dried in reduced pressure environment (at 70 deg C.) (for 2 hours). Thereby, black electrophoretic particles configured of a polymer coated pigment were obtained.

### Experimental Example 6

In Experimental Example 6, both the electrophoretic particles 10 and the porous layer 20 were positively charged. In Experimental Example 6, a display unit was fabricated by a procedure similar to that of the foregoing Experimental Example 2, except for preparation of the porous layer 20.

[Preparation of Porous Layer]

Next, 15 g of POLYMENT NK-380 (available from Nippon Shokubai Co., Ltd., molar weight: 100000) as a formation material of a fibrous structure was dissolved in 75 g of DMF to prepare the solution D. Subsequently, as non-electrophoretic particles, for example, 40 g of titanium oxide (TITONE R-42 available from Sakai Chemical Industry Co., Ltd.) was added to 60 g of the solution D, and thereafter, the resultant was mixed by a beads mill to obtain a spinning solution. Subsequently, the spinning solution was thrown in a syringe, and 8 round trips of spinning were performed with the use of an electric field spinning apparatus (NANON, available from MECC Co., Ltd.) on a glass substrate on which pixel electrodes (ITO) in the shape of a predetermined pattern was formed. As spinning conditions, electric field intensity was 28 kV, discharge rate was 0.5 cm³/min, spinning distance was 15 cm, and scanning rate was 20 mm/sec. Subsequently, the glass substrate was dried for 12 hours in a vacuum oven (at 75 deg C.) to form a fibrous structure containing the non-electrophoretic particles.

### Experimental Example 7

In Experimental Example 7, both the electrophoretic particles 10 and the porous layer 20 were positively charged. In Experimental Example 6, a display unit was fabricated by forming the electrophoretic particles 10 by the procedure of Experimental Example 1 and forming the porous layer 20 by the procedure of Experimental Example 6.

As performances of the display units of Experimental Examples 1 to 7, black reflectance (%), white reflectance (%), and contrast were examined. Results illustrated in Table 1 were obtained.

Upon measuring the black reflectance and the white reflectance, with the use of a spectrophotometer (MCPD-7000 available from Otsuka Electronics Co., Ltd.), each reflectance in a normal line direction with respect to a referential diffusion plate was measured in ring lighting. In this case, a voltage at which reflectance is stable both in the black display and the white display was set to a driving voltage (in this case, 15 V), and each reflectance in each display state was regarded as the black reflectance or the white reflectance. It is to be noted that the contrast was a value obtained by dividing the white reflectance by the black reflectance.

TABLE 1

| | Electrophoretic particles | | Porous layer | | | | |
|---|---|---|---|---|---|---|---|
| | Electric | Functional | Electric | Functional | Black | White | Contrast |
| | charge | group | charge | group | reflectance | reflectance | ratio |
| Experimental | − | Carboxyl | − | Cyano | 1% | 50% | 50 |
| Example 1 | | | | group | | | |
| Experimental | + | Amino | − | Cyano | 2% | 35% | 17.5 |
| Example 2 | | group | | group | | | |
| Experimental | − | Hydroxyl | − | Cyano | 1% | 45% | 45 |
| Example 3 | | group | | group | | | |
| Experimental | − | Cyano | − | Cyano | 1% | 45% | 45 |
| Example 4 | | group | | group | | | |
| Experimental | − | Ether | − | Cyano | 2% | 45% | 22.5 |
| Example 5 | | group | | group | | | |
| Experimental | + | Amino | + | Amino | 2% | 40% | 20 |
| Example 6 | | group | | group | | | |
| Experimental | − | Carboxyl | + | Amino | 5% | 25% | 5 |
| Example 7 | | | | group | | | |

In Experimental Examples 1, 3, 4 (, 5) in which both the electrophoretic particles 10 and the porous layer 20 were negatively charged, each contrast ratio thereof was improved twice or more (about 1.3 times in Experimental Example 5) of the contrast ratio of Experimental Example 2 (the electrophoretic particles 10 were positively charged and the porous layer 20 was negatively charged) having a configuration used for the reflective display unit of Comparative example. Further, in Experimental Example 7 having an opposite configuration (the electrophoretic particles 10 were negatively charged and the porous layer 20 was positively charged) of that of Experimental Example 2, the contrast ratio was lowered more largely than in Experimental Example 2. However, in Experimental Example 7, by positively charging the electrophoretic particles 10 as the porous layer 20 as in Experimental Example 6, the contrast ratio was increased and improved four times as in Experimental Examples 1, 3, and 4. It is to be noted that difference in improvement ratio between the contrast ratios of Experimental Examples 1, 3, and 4 and the contrast ratio of Experimental Example 5 was caused by difference in materials of the fibrous structure 21 configuring the porous layer 20. Further, the low contrast ratio of Experimental Example 7 was caused by the following reason. In general, in the case where the positively-charged porous layer 20 is formed, as in Experimental Example, 7, it is often the case that the functional group thereof is an amino group. The amino group has a larger molecule and has a large volume compared to, for example, a cyano group or the like. Therefore, while electrophoretic migration is repeated, mobility of electrophoretic particles in fine pores of the porous layer is lowered, resulting in lowered contrast ratio.

Accordingly, by allowing the charging polarity of the electrophoretic particles 10 and the charging polarity of the porous layer 20 to be the same, the contrast ratio of the display unit is improved. In particular, it is found that in the case where the electric charge of the electrophoretic particles 10 is prepared to be the same as the electric charge (negative) of the porous layer 20, a higher contrast ratio is obtained. Further, it is found that the foregoing does not depend on types of functional groups added to the electrophoretic particles.

While the present technology has been described with reference to the embodiment, the present technology is not limited to the modes described in the foregoing embodiment, and various modifications may be made. For example, application of the electrophoretic element of the present technology is not limited to the display unit, and the electrophoretic element of the present technology may be applied to other electronic apparatuses.

The present technology may have the following configurations.

(1) An electrophoretic element, including:

an insulating liquid;

a plurality of electrophoretic particles provided in the insulating liquid; and

a porous layer provided in the insulating liquid and having a fibrous structure, wherein

the electrophoretic particles and the porous layer have same charging polarity as one another.

(2) The electrophoretic element according to (1), wherein the electrophoretic particles have the charging polarity that is same as the charging polarity of the porous layer.
(3) The electrophoretic element according to any one of (1) or (2), wherein the fibrous structure includes a plurality of non-electrophoretic particles having an optical reflection characteristic that is different from an optical reflection characteristic of the electrophoretic particles.
(4) The electrophoretic element according to any one of (1) to (3), wherein the fibrous structure is made of one of a polymer material and an inorganic material.
(5) The electrophoretic element according to any one of (1) to (4), wherein an average fiber diameter of the fibrous structure is from 0.1 μm to 10 μm both inclusive.
(6) The electrophoretic element according to any one of (1) to (5), wherein the fibrous structure is formed by an electrostatic spinning method.
(7) The electrophoretic element according to any one of (1) to (6), wherein the fibrous structure is a nanofiber.
(8) The electrophoretic element according to any one of (3) to (7), wherein the electrophoretic particles and the non-electrophoretic particles are each made of one of an organic pigment, an inorganic pigment, a dye, a carbon material, a metal material, a metal oxide, glass, and a polymer material.
(9) The electrophoretic element any one of (3) to (8), wherein reflectance of the non-electrophoretic particles is higher than reflectance of the electrophoretic element.
(10) A method of manufacturing an electrophoretic element, the method including:

forming electrophoretic particles;

forming a porous layer configured of a fibrous structure; and

introducing a functional group to one of the electrophoretic particles and the porous layer, the functional group adding a charging polarity to the one of the electrophoretic particles and the porous layer that is same as a charging polarity of the other one of the electrophoretic particles and the porous layer.

(11) A display unit with an electrophoretic element provided between a pair of base substances, one or both of the base substances being light transmissive and each of the base substances being provided with an electrode, the electrophoretic element including:

an insulating liquid;

a plurality of electrophoretic particles provided in the insulating liquid; and

a porous layer provided in the insulating liquid and having a fibrous structure, wherein

the electrophoretic particles and the porous layer have same charging polarity as one another.

The present application is based on and claims priority of Japanese Patent Application JP 2011-255211 filed in the Japan Patent Office on Nov. 22, 2011, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

1. An electrophoretic element, comprising:
an insulating liquid;
a plurality of electrophoretic particles provided in the insulating liquid; and
a porous layer provided in the insulating liquid and having a fibrous structure, wherein
the electrophoretic particles and the porous layer have same charging polarity as one another.

2. The electrophoretic element according to claim 1, wherein the electrophoretic particles have the charging polarity that is same as the charging polarity of the porous layer.

3. The electrophoretic element according to claim 1, wherein the fibrous structure includes a plurality of non-electrophoretic particles having an optical reflection characteristic that is different from an optical reflection characteristic of the electrophoretic particles.

4. The electrophoretic element according to claim 1, wherein the fibrous structure is made of one of a polymer material and an inorganic material.

5. The electrophoretic element according to claim 1, wherein an average fiber diameter of the fibrous structure is from 0.1 μm to 10 μm both inclusive.

6. The electrophoretic element according to claim 1, wherein the fibrous structure is formed by an electrostatic spinning method.

7. The electrophoretic element according to claim 1, wherein the fibrous structure is a nanofiber.

8. The electrophoretic element according to claim 3, wherein the electrophoretic particles and the non-electrophoretic particles are each made of one of an organic pigment, an inorganic pigment, a dye, a carbon material, a metal material, a metal oxide, glass, and a polymer material.

9. The electrophoretic element according to claim 3, wherein reflectance of the non-electrophoretic particles is higher than reflectance of the electrophoretic element.

10. A method of manufacturing an electrophoretic element, the method comprising:
forming electrophoretic particles;
forming a porous layer configured of a fibrous structure; and
introducing a functional group to one of the electrophoretic particles and the porous layer, the functional group adding a charging polarity to the one of the electrophoretic particles and the porous layer that is same as a charging polarity of the other one of the electrophoretic particles and the porous layer.

11. A display unit with an electrophoretic element provided between a pair of base substances, one or both of the base substances being light transmissive and each of the base substances being provided with an electrode, the electrophoretic element comprising:
an insulating liquid;
a plurality of electrophoretic particles provided in the insulating liquid; and
a porous layer provided in the insulating liquid and having a fibrous structure, wherein
the electrophoretic particles and the porous layer have same charging polarity as one another.
